(19) United States
(12) Patent Application Publication
(10) Pub. No.: US 2015/0019310 A1
(43) Pub. Date: Jan. 15, 2015

(54) ELECTRONIC SYSTEM AND METHOD FOR GROUP PURCHASING PROMOTIONS

(71) Applicants: Jeffrey Young, Greenwich, CT (US); Jeffrey Lederer, Greenwich, CT (US)

(72) Inventors: Jeffrey Young, Greenwich, CT (US); Jeffrey Lederer, Greenwich, CT (US)

(21) Appl. No.: 13/942,207

(22) Filed: Jul. 15, 2013

(51) Int. Cl. G06Q 30/02

(52) U.S. Cl. CPC G06Q 30/0223
USPC 705/14.16

(57) ABSTRACT

An automated group promotion electronic system. A Group-Buy-Promotion (GBP) server and client system together with a product management back end database system are implemented. Deals based on the number of participants are created, posted and broadcasted. Dynamic market changes of a product-for-sale are tracked. Group buying and information broadcasting are automated with an ease of use. Credits are provided to customers who participate in a Deal at the end of a Deal to encourage group and volume purchases and are also tracked. Regardless a particular customer's purchasing power, whether a retail customer, a wholesale merchant or large scale government procurement; a participant, of any size, benefits from other customers participating in a particular Deal.

### BACKGROUND OF THE INVENTION

1. Field of the Invention

The present invention relates to an electronic system that automatically performs group purchasing promotions. More particularly, the present invention provides an electronic system with unique computer algorithms that allow for automatic advocating for group purchasing transactions and product information spreading and advertising.

2. Description of the Related Art

Numerous computer based systems for promoting customer loyalty have been developed. These systems can be categorized into several groups. One such example is represented by www.ebay.com where customers get to bid on interested items for lower than usual prices. Another example is represented by www.amazon.com where some promotion may be dramatically discounted, or sales may be scheduled at an unconventional time to create a level of shopping excitement. Automatic incentives are provided when certain level of purchases are reached by individual customers. For example, a cash incentive of $25 may be provided for reaching $100 purchase. Another example is the “frequent flyer” programs implemented in the airline industry for promoting customers to stay with the same airline for traveling. Further, the patented “name your own price” program exemplified by www.priceline.com also helps promote good will among customers. All these systems are built on promoting individual shopping experiences and transactions.

Other systems such as described in the U.S. Pat. No. 8,065,182 B2, the entire contents of which are incorporated herein by reference, are implemented for the needs of manufacturers and wholesalers for promoting volume purchases and brand loyalties, independent of the retailers.

All these electronically managed sales systems utilize computerization or electronic technology for product management and customer information services, where specific algorithms are developed for electronically managing customer feedback and comments, point-of-sale (POS) systems for automated checkout procedures, automated product updates for sellers, product tracking etc. For example, products may be tracked with a Universal Product Code (UPC) for shipping and returning statuses. A retailer may track an item with a Stock Keeping Unit (SKU) number or code for identifying and monitoring a specific item's status. Registered customers are assigned customer IDs for purchasing history and account management.

Electronic hardware systems are developed to accommodate these functions. For example, in a retailer store, a POS terminal, a kiosk terminal, or a sales person's hand-held terminal might be coupled to a computer system, such as a network server or some other store platform host, which is enabled to recognize and process UPC and/or SKU information. While the UPC and/or SKU information may be either manually keyed-in or ‘sensed-in’ and interpreted by a device, such as a barcode reader, coupled to the terminal. With internet based sale systems, the selection of an item may prompt the input and submission of the UPC and/or SKU to a server system. A computer server system would conventionally include a database that stores information relating to a retailer's product inventory, stocked merchandise using a UPC and/or SKU number for each item of merchandise, and various other types of merchandise identification information, such as price, inventory, style, color, size, etc. When a customer purchases an item of merchandise, store personnel frequently use an automated terminal to check out the product price information.

However, conventional electronic product management and sales systems are only passively involved in the shopping process, and mostly are substantially limited on an individual level. Static information about whether an item is available and what are the product characteristics and specifications are searched and updated periodically. The monitored information does not reflect the dynamic changes of the market or the excitement and desires associated with customers as a group with a particular sale item. The conventional product tracking systems are also based on individual customer purchase behaviors, and are not capable of creating a group purchasing promotional atmosphere that connect and stimulate the customer's social activities.

In view of the forgoing, an automated computer system is needed that is designed to satisfy the market desires generated from group and social behaviors. Particularly, there is a need in such system that gives a customer the motivation and satisfaction in sharing the excitement of a purchase with others and simultaneously benefiting from sharing and spreading his/her excitement.

### ASPECTS AND SUMMARY OF THE INVENTION

The present invention provides a novel automated group promotion electronic system. In one embodiment, a Group-Buy-Promotion (hereafter alternatively GBP) server and client system together with a product management back end database system are implemented. Deals based on the number of participants are created, posted and broadcasted (it is noted that the word ‘deal’ or ‘deals’ may be used in a specific sense via ‘Deal’ or ‘Deals’ without limiting the scope of the present invention as will be understood by one of skill in the art). Dynamic market changes of a product for sale are tracked. Group buying and information broadcasting are automated with great ease of use. Customers are encouraged to participate in group and volume purchases. Regardless of a particular customer's purchasing power, whether a retail customer a wholesale merchant or large scale government procurement, a participant (small or large) can benefit from other customers' participating of a particular Deal.

In another embodiment, a Deal master system is implemented to allow a Deal to be structured and activated or inactivated based on a market sale status of the item.

In another aspect of an embodiment, a built-in Broadcast system allows a particular participant in a Deal to spread sale information automatically to various social groups, twitter users or email groups.

In another aspect of an embodiment, a built-in alert system is implemented to automatically and periodically alert various groups and email recipients the current market status of a Deal.

In another embodiment, an account management system allows a user to directly access the Deal master system to structure a Deal, to participate in a Deal, to join groups and subgroups, and to allow for credits for referrals and credits for an actual price paid at the end of a Deal, and benefit from price discounts by participating in a Deal.

In another embodiment, a price management system is implemented to reflect the market price based on a Deal structure, the status of reaching a particular milestone in sales or other specifications.

In another embodiment, a Deal status management system is implemented to actively manage a Deal based on the current instructions of the Deal owner. The status management system is linked with a Broadcast system and an alert system for spreading and updating the current changes of the Deal.

In another embodiment, an order interface is implemented to display a current Deal status and an order form is automatically generated. Orders can be automatically sent through the email server to a Deal owner or Deal Broadcast originator.

In another embodiment, a product management is implemented to constantly store and record the status of a Deal in real time, and to interact with the account management system to allow for status information retrieval and update.

In another embodiment, an item master system is implemented to automatically directly update new item information by a manufacturer or by a Deal owner through the using of the combinations of UPC and SKU systems.

In another embodiment, an automatic email system is implemented to allow for multiple language tools and the automatic attachment of an order or a Broadcast to an email to an originator of a Deal or to a particular distributor.

The above and other aspects, features and advantages of the present invention will become apparent from the following description read in conjunction with the accompanying drawings, in which like reference numerals designate the same elements.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows various functional components in an example Group-Buy-Promotion (GBP) server system in accordance with this application.

FIG. 2 schematically shows the functional relationships between an example account management system, an example product master system and an example Deal master system in an example GBP server system in accordance with this application.

FIG. 3 schematically shows an example functional flowchart of a price management system in accordance with this application.

FIG. 4 schematically shows an example functional flow chart of a Deal master system in accordance with this application.

FIG. 5 schematically shows example interactions between an end user and a distributor of an account management system in accordance with this application.

FIG. 6 schematically shows exemplary functional components for an order interface in accordance with this application.

FIG. 7 shows an exemplary order interface graphic design in accordance with this application.

FIG. 8 shows an exemplary automated Purchase Oder in accordance with this application.

FIG. 9 shows an exemplary auto-generated email for submitting an order in accordance with this application.

FIG. 10 schematically shows a functional flowchart between a GBP interface and a product the back end product management system in accordance with this application.

FIG. 11 schematically shows a functional flowchart for broadcasting a Deal in accordance with this application.

FIG. 12 shows an exemplary user interface of an example Broadcast system in accordance with this application.

FIG. 13 shows example interactions with other social networks by a Broadcast system in accordance with this application.

FIG. 14 shows an example Broadcast email in accordance with this application.

FIG. 15 shows another Broadcast interface in accordance with this application.

FIG. 16 shows functional interactions for account management in accordance with this application.

FIG. 17 shows an example set of system user tools for customization in accordance with this application.

FIG. 18 shows an example Referral System in accordance with this application.

### DETAILED DESCRIPTION OF THE PREFERRED EMBODIMENTS

Reference will now be made in detail to embodiments of the invention, Wherever possible, same or similar reference numerals are used in the drawings and the description to refer to the same or like parts or steps. The drawings are in simplified form and are not to precise scale. For clarity reasons, only the key and essential components are shown in the drawings, commonly known functional components are generally omitted. The word “system” generally includes both software and all the necessary computing hardware (memory, processors, connectors, switches, etc.) for executing the software encoded functions. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable, Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, Java, COBOL, assembler, PERL, or the like, with the various algorithms being implemented with any combination of data structures, objects, processes, routines, or other programming elements. Further, it should be noted that the present invention may employ any number of conventional techniques for data transmission, signaling, data-processing, network control, and the like. For a basic introduction to cryptography, please review a text written by Bruce Schneider which is entitled “Applied Cryptography: Protocols, Algorithms, And Source Code In C,” published by John Wiley & Sons (second edition, 1996), which is hereby incorporated fully by reference.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

Communications between participants in the system of the present invention are accomplished through any suitable communication means, such as, for example, a telephone network, public switch telephone network, intranet, Internet, extranet, WAN, LAN, point of interaction device (e.g., point of sale device, personal digital assistant, cellular phone, kiosk terminal, automated teller machine (ATM), etc.), online communications, off-line communications, wireless communications, satellite communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

It further will be appreciated that users may interact with like systems via any known or to-be-known operative input devices, including for example, a keyboard, mouse, kiosk, personal digital assistant, handheld computer (e.g., Palm PILOT®, IPAD®), cellular phone, and/or the like. Similarly, the invention could be used in conjunction with any type of personal computer, network computer, workstation, minicomputer, mainframe, or the like, running any operating system, such as any version of Windows®, Windows NT®, MacOS®, OS/2®, BeOS®, Linux®, UNIX®, or the like. Moreover, although the invention may be described herein as being implemented with TCP/IP communications protocols, it will be readily understood that the invention could also be implemented using IPX®, Appletalk®, IP-6®, NetBIOS®, OSI®, or any number of existing or future protocols. Moreover, the system contemplates the use, sale, or distribution of any goods, services, or information over any network having similar functionality described herein.

Each participant or user of the system of the present invention, including purchasers, retailers, manufacturers, and a third-party providers, may be equipped with a suitable computing system to facilitate online communications and transactions with any other participants. For example, some or all participants may have access to a computing unit in the form of a personal computer, although other types of computing units may be used, including laptops, notebooks, handheld computers, set-top boxes, kiosk terminals, and the like. Additionally, other participants may have computing systems which may be implemented in the form of a computer-server, a PC server, a networked set of computers, or any other suitable implementations which are known in the art or may hereafter be devised.

The computing systems may be connected with each other via a data communications network as described more fully herein. For example, the network may be a public network, which is assumed to be insecure and open to eavesdroppers. In one embodiment, the network is embodied as the Internet.

In this context, the computers may or may not be connected to the Internet at all times. For instance, the consumer's computer may employ a modem to occasionally connect to the Internet, whereas the retailer computing system, the manufacturer computing system, and the central rewards mechanism might maintain a permanent connection to the Internet. It is noted that the network may be implemented as other types of networks, such as an interactive television (ITV) network.

The retailer's computer system may also be interconnected to a third-party provider via a second network, referred to as a payment network. The payment network represents existing proprietary networks that presently accommodate transactions for credit cards, debit cards, and other types of financial instruments or banking cards. The payment network is a closed network that is assumed to be secure from eavesdroppers. Examples of the payment networks include, without limitation, the America EXPRESS®, VISANET®, and the VERIPHONE® networks.

As will be appreciated by one of ordinary skill in the art, the present invention may be embodied as a method, a data processing system, a device for data processing, and/or a computer program product or any combinations thereof. Accordingly, aspects of the present invention may take the form of an entirely software embodiment, an entirely hardware embodiment, or combining aspects of both software and hardware embodiment. Furthermore, the present invention may take the form of a computer program product on a computer-readable storage device having computer-readable program-code embodied in the device. Any suitable computer-readable storage device may be utilized, including hard disks, CD-ROM, flash drives, optical storage devices, magnetic storage devices, and/or the like without departing from the scope and spirit of the present invention.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create an instrument for implementing the functions specified in the flowchart block or blocks.

These computer program instructions may also be stored in a computer-readable memory chip that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations herein, and combinations of functional blocks in the block diagrams and flowchart illustrations, can be implemented by either special purpose, hardware-based computer systems which perform the specified functions or steps, or suitable combinations of special purpose hardware and computer instructions.

As used herein, the terms “user” and “participant” shall interchangeably refer to any person, entity, charitable organization, machine, hardware, software, or business who accesses and uses the system of the invention, including consumers, distributors, end users, Deal originators, Deal brokers, retailers, manufacturers, and third-party providers. Participants in the system may interact with one another either online or off-line. As used herein, the term “online” refers to interactive communications that takes place between participants who are remotely located from one another, including communication through any of the networks or communications means described above or the like.

As used herein, the terms “purchaser”, “customer”, “consumer”, and “end-user” may be used interchangeably with each other, and each shall mean any person, entity, charitable organization, or business which uses a consumer ID to participate in the present system. A “consumer ID”, as used herein, includes any device, code, or other identifier suitably configured to allow the consumer to interact or communicate with the system, such as, for example, a reward card, charge card, credit card, debit card, prepaid card, telephone card, smart card, magnetic stripe card, bar code card, authorization access code, personal identification number (PIN), Internet code, other identification code, and/or the like. Additionally, a “consumer ID” may comprise any form of electronic, magnetic, and/or optical device capable of transmitting or downloading data from itself to a second device which is capable of interacting and communicating with such forms of consumer ID.

As used herein, the term “UPC” and the phrase “manufacturer item identifier” shall refer to any symbol or indicia which provides information and, in an exemplary embodiment, shall refer to any number, code, or identifier assigned by a manufacturer and associated with an item, including any type of goods and/or services, ultimately offered to a consumer or other end-user. Colloquially, a UPC is sometimes referred to as a SKU number. However, as used herein, the term “SKU” and the phrase “retailer item identifier” shall refer to any symbol or indicia which provides additional information and, in an exemplary embodiment, shall refer to any number, code, or identifier assigned by a retailer and associated with an item, including any type of goods and/or services, offered to a consumer or other end-user. “Item” and “Product” are used interchangeably.

The Group-Buy-Promotion (GBP) system is preferably implemented either based on a client-server model or a direct machine-machine communication system, with internet and/or wireless communication networks. For clarity reasons, the drawings are shown based on the client-server model wherein a central server function is implemented, but are not limited thereof.

The term “deal” (hereinafter Deal) in this application means a specific pre-defined offer for a specific item for sale placed by a Deal originator or a Deal broker. The GBP system enables users to get discounted prices on products/items by participating in group purchase Deals. Each Deal will be for one specific product/item and will have a specific start date and specific expiration date. Deals will generally be priced in such a way that as the quantity of pieces for all orders placed increases the “per piece” price will decrease. For a non-limiting example, a Deal is set for a round stress reliever and assuming the opening “price” is $1.30 per stress reliever. The Deal may be structured so that the price will drop to $1.00 per stress reliever if an aggregate of 10,000 stress relievers are ordered and $0.75 per stress reliever if the aggregate quantity reaches 25,000. The initial purchasers would have to commit to the $1.30 per piece charge. If the aggregate quantity reaches 10,000 or 25,000 the price will change and the original purchasers will receive a credit for the difference between what they paid and the current price. Thus, in the GBP system, everyone who participates in a Deal will pay the lowest price as the sales increases.

A Deal may also be structured so that each buyer will commit to pay whatever price is current when they place their order. In this type of Deal, orders from individual buyers will be processed immediately upon receipt.

For all Deals, regardless of the price committed to, the actual price charged in Deal will be whatever price is current when the order is shipped. Regardless of the price charged at the time of shipment, all participants in a Deal will benefit from the lowest price when the Deal expires with each step of a purchase credit or discount applying to the reach of each sale milestone. Any buyers who paid a higher price will receive a site credit or refund for the difference. Site credits may or may be not redeemable for cash, or they may only be used for future purchases on the site.

Another example type of Deal is one in which the Deal does not become a Deal until a certain minimum quantity of pieces is reached. So, for example, if the Deal requires a total commitment of 25,000 units by all buyers, no orders may be processed until the minimum quantity is aggregated.

Another example type of Deal is one in which the Deal does not become a Deal until a certain minimum number of users is reached. For example, if the Deal requires the commitment of 25 users to purchase a unit, no orders are processed until the minimum number of users is met. The product may have one set price or may decrease as more users purchase.

Another example type of Deal is one based around a coupon, similar to the coupons offered on sites like GROUPON®, LIVINGSOCIAL®, etc. For example, a coupon Deal might offer $500 worth of promotional products for $300. And like the GROUPON®-type offers, this coupon might require a minimum number of purchasers before the Deal is “on”.

The status of each Deal type may be set to be “Active”, “Request” or “Inactive”. In the “Active” status, the Deal is posted and its time is in progress. Users are able to place orders for this Deal. In the “Request” status, the Deal is posted but time has not yet begun. The Deal time will begin when a user places the first order for this Deal. When the Deal begins, it is changed to “Active” status and all users with adequate permissions can place orders. In the “Inactive” status, the Deal time of any posted Deal has either expired or invalidated or cancelled. Users can no longer place orders for “Inactive Deal”.

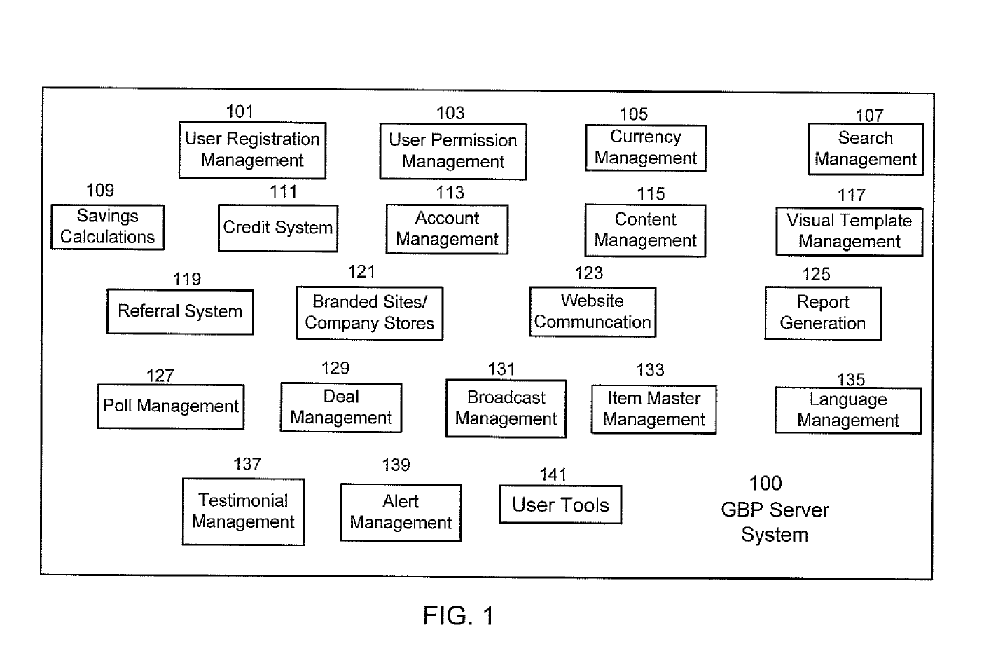

In reference to FIG. 1, a Group-Buy-Promotion (GBP) server 100 comprises multiple functional components including, but not limited to, User Registration Management 101, User Permission Management 103, Currency Management 105, Search Management 107, Savings Calculations 109, Credit Management System 111, Account Management System 113, Content Management System 115, Virtual Template Management 117, Referral System 119, Company Store/Sites Management 121, Website Communication 123, Report Facility 125, Poll Management 127, Deal Management 129, Broadcast Management 131, Item Management 133, Language Management 135, Customer Feedback 137, Alert Management 139, User Tools 141, etc. Each of the functional components may be called to perform independently and/or in a parallel manner.

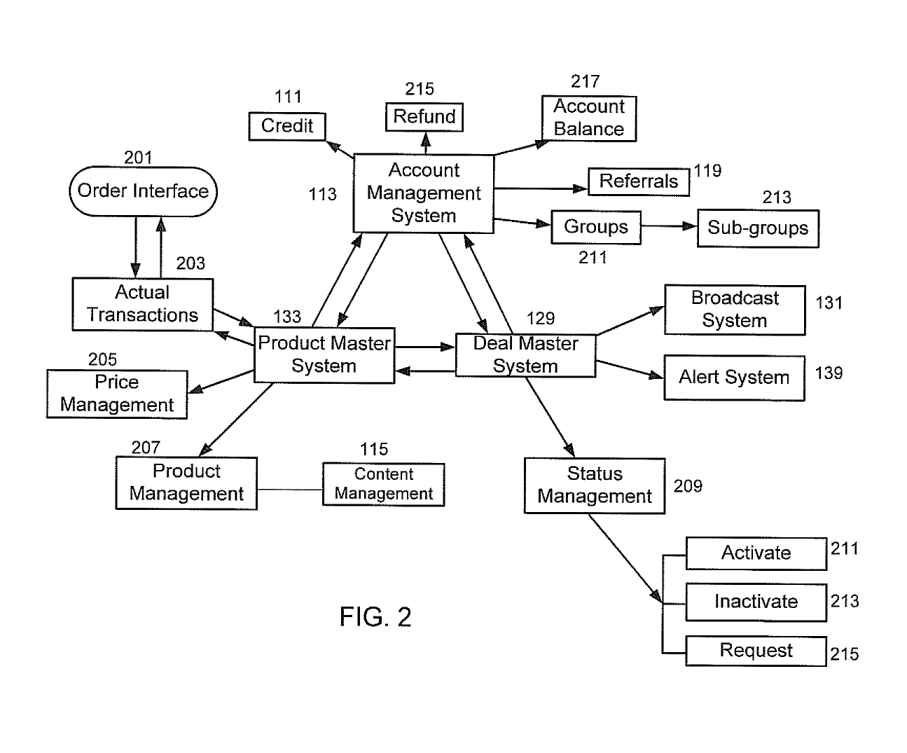

In reference to FIG. 2, the GBP system is generally based on the interactions of three major components: Account Management System 113, Deal Master System 129 and Product Master System 133. The three components and their sub-components are operably available to each other to be called upon, and to be performed in parallel and independently in the system. They may be also globally available to generally users, regardless their status of being registered or unregistered. During operation, multiple instances of each functional component may be created to accommodate plurality of simultaneous users, while each actual transaction of sales may happen sequentially to ensure the accuracy of the item status. A first-in first-out (FIFO) sequence queue may be used to process each purchase order transaction performed by a transaction handler instance of the system. Multiple transaction handler objects/instances may be created in batches to increase efficiency in performance when there are large numbers of users or requests.

For Account Management System 113, users need to be registered to be assigned an account. User registration types may include Administrator, Manufacturer, Suppler, Distributor, and End User. A System Admin is enabled to restrict users from accessing certain website features, areas and information. System Administrators may be able to modify user settings on a registration group basis, for example, all Distributors may access feature X, or on an individual user basis, or all Distributors can access X feature but only Distributor 549 can access Y feature additionally. These permissions are adjustable on a feature and field basis. Some End Users may not be able to access certain fields, and End Users do not have an ASI or PPAI registration field.

For Manufacturer, Suppler, Distributor type users, their ASI or PPAI numbers may be requested, and the GBP approval system would confirm that the AST number and billing zip code provided by the user match the list provided by GBP. When a discrepancy is detected, the user account may be registered but the Manufacturer, Suppler, Distributor associated functions may be temporarily disabled. Discrepancy in registration would prompt an email alert to the Administrator requesting that the account be reviewed. Accounts with and without discrepancies require an email confirmation for activation. The email confirmation is automatically sent to the user once the account is deemed approved or by the Administer. User information will be stored in a database with the ability to transfer to a different server if necessary. More than one user ID may be created for any given ASI or PPAI or other Trade Association membership IDs. In use, Users are able to modify their personal registration information at any time; the Administrator is able to modify user group registration information and permissions. Administrators can also modify User Information with a user's permission, and order information with a purchaser's permission.

Users are able to modify the information they have provided in Account Management. Account management is inclusive of Alert and Broadcast preferences, Order Management and Communication preferences, account balance credits Management Settings, Deal Master preferences, Item Master preferences, and Report generation preferences. All Users have access to various tools, such as Savings Calculations, Language tools, Currency Management, Search Management, Virtual Samples, Polls, Live Chat, shopping cart, Order Status, Entity Relation diagrams, phone applications, time zone adjustments, Budgeting Tools. Non-registered users do not have Account Management access and its associated sub-functions, such as credit management, Deal participation etc.

Search functions 107 generally include standard keyword search in which a user simply types a keyword to search or advanced search in which a user can provide additional information to find a more specific product. The fields for this content are gathered directly from databases, and cannot be modified by an Administrator. A Search may also be used to find a distributor's branded site where a user can register based on the zip code they provide.

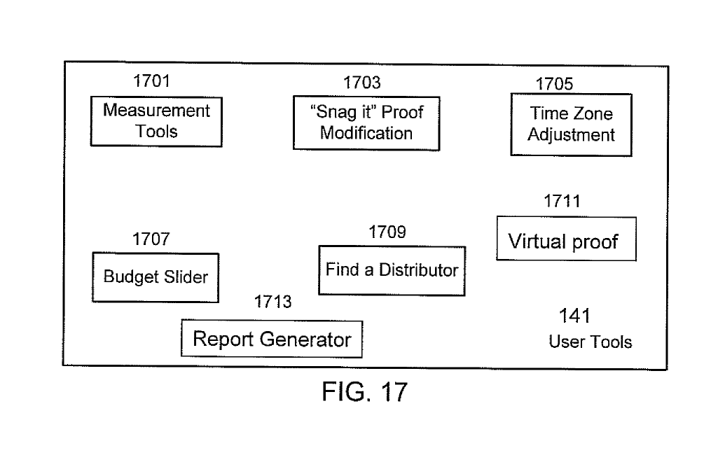

As shown in FIG. 17, there are globally available user tools 141. For example, Virtual Proof functions 1711 are provided for users to create virtual proofs using incorporated graphic design tools, such as TECHNOLOGOS™. Similar to a personal signature or a stamp, this function allows a user to draw on proof when approving with changes or requesting a revision.

Budgeting tool 1707 would allow a user to enter budget or number of pieces and reflects the change in a Deal and prices and savings that they would potentially get, but this does not change the active Deal until the user is registered and the order is placed. The user will have the option to use a slider like tool to control the quantity and it will display the budget of the total quantity. The tool may be designed like a thermometer.

GBP is connected with GOGGLE® translate for translations of all text fields (banners and graphics are excluded). The website admin is able to set limitations on what languages the website can be translated into by Language Management 135. All users are able to translate the website into any of the pre-selected languages.

The website admin is able to decide what currencies are available for conversion of Deal pricing. The GOOGLE currency converter/rate tool may be used to calculate the prices in the selected currency. Manual rate updates are not required.

Certain features are exclusive for registered users. Account Management System 113 is implemented to have exclusive access to Credit management 111, Refund management 215, Account Balance management 217, Referral management 119, formation and management of Groups 211 and Sub-groups 213. Non-registered users may not access these functions.

Referral management 119 allows a Registered Users to refer others to the GBP website for benefits. Users earn benefits each time a person who they send a referral to registers. The referral tool provides a customized link for the registered user. This link directs users to the registration page and tracks how many users used this link to register. Depending on the referral incentive at the time, the users may earn site credit or are entered in raffles based on how many people used their customized link to register. When site credit is awarded, the referral tool calls on the credit system function to adjust site credit as it is earned. The site administrator must be able to set restraints on how much site credit can be earned and adjust the amount of site credit earned per person registered. This may apply to a raffle option. For the raffle option, the system tallies how many users have registered via the customized link and make this information available to the website admin.

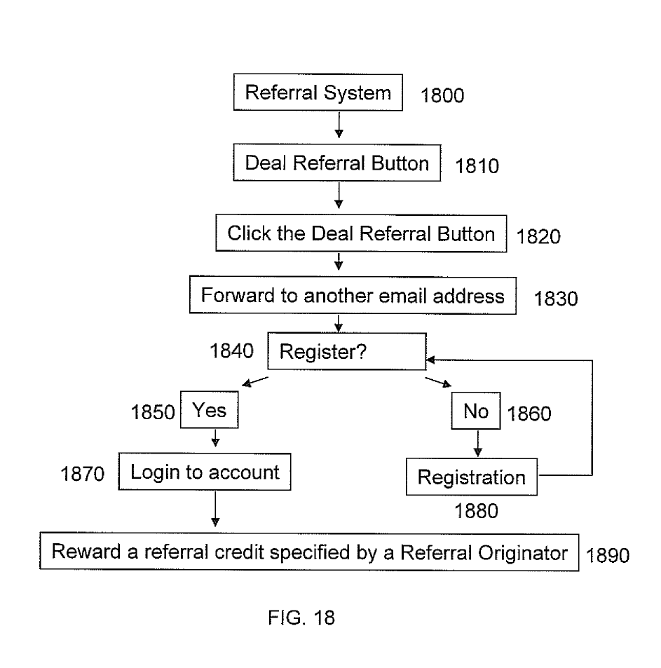

As shown in FIG. 18, an example Referral System 1800 for Deals may also allow for automatic credits being rewarded to any registered users who send a referral to an email address. A Deal originator/creator may provide a web page that contains a Referral Button for a Deal at step 1810. A user may click on the Referral Button at step 1820 which then automatically prompt a forward web page requesting the user to input an email address to refer the Deal to at step 1830. After the user finished forwarding the Deal to another email address, the Referral System checks to see if this user is registered at step 1840. If the user is not registered, he/she is then prompted to a Registration Page of the GBP system at steps 1860 and 1880. If the user is registered, he/she is prompted to login into his/her account at step 1850 and 1870. Then Referral System 1800 will automatically reward the user a credit which was set by the Deal originator at step 1890.

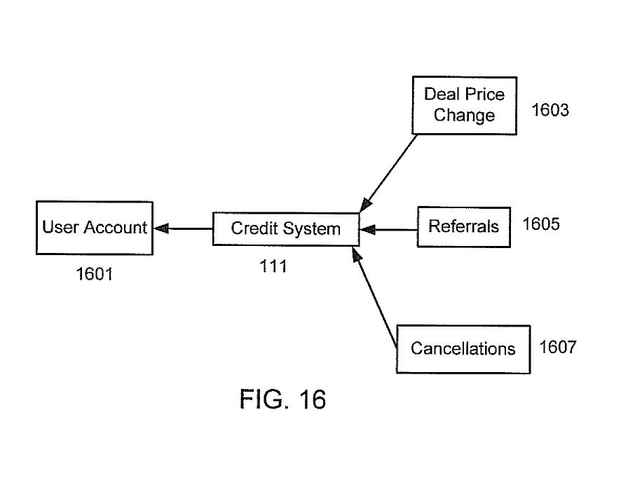

As shown in FIG. 16, Credit system 111 is linked with user accounts 1601 and specific “Deals”. Credit system 111 updates website credit in each of the following scenarios: Cancellations 1607, Deal Price Change 1603, and Referral Bonus 1605. The credit system then applies this website credit to the user accounts. Credit history is logged for a user to view and the account balance is updated immediately as credit is used or earned. Credit system 111 is also linked with a shopping cart functionality to provide the option for the user to apply their earned credit to an order. The user is able to enter what amount of their earned credit they would like to apply to the order.

At the end of each Deal, the credit system is able to auto-calculate the difference between the item price charged to the user's credit card and the item price at the end of the Deal. Or a fixed purchase credit may be applied to a purchase. The credit system uses this price difference to calculate the credit that will be applied to the user's account based on the number of pieces that user ordered. The credit system is also linked with the referral tool 119.

For cancellations, the user's credit card may be charged for only the cost of the pieces at the time the Deal closes. This amount is credited to their account balance or refunded through other means.

Distributor or Manufacturer Users, Deal Brokers or Deal Originator Users are allowed to create Groups by Group Functions 211 and 213 and to be group representatives. An End User may also register to be a group representative if a certain number of users register together. For example, a group of 10 people register together, one of the users may be a group representative to receive group emails and updates and alert. Group specific benefits may be assigned by a Deal originator or a Deal broker.

Group access can also be granted to a Deal originator or Deal broker or a particular Distributor or other registered group representatives. For example, a Distributor may create a sub-group for all end users who have listed IBM as their company. This Group of users can access to the IBM company store that the distributor has created. GBP may enable distributors to message the supplier of their order directly based on group IDs.

Product Master System 133 is implemented to interact with Transaction Controller 203 which in turn interacts with the Order Interface 201, Price Management System 205, Product Management system 207 and its sub component 115.

Product Master System 133 includes a group of functions that access product databases and store all product information, images and set price information for use in “Deals”. Product Master System 133 is capable of identifying specific imprint methods and connecting them with their proper pricing. For a non-limiting example, if a product has two imprint types: Imprint Method 1 has a set-up charge of $70.00 for up to three colors; the fourth color set-up charge is $44.00 with a running charge of $0.45. Imprint Method 2 has a set-up charge of $32.00 which includes the first color; there is a set-up charge of $32.00 and a running charge of $0.22 for each additional color. Product Master 133 would correlate these prices with what is referenced in the Deal and what is selected by the customer by calling upon Price Management 205 to calculate out the order price. The pricing of the order would be configured based on the rules of that product from the Product Master and the Deal configuration from Deal Master System 129.

Product databases store various product related information. The website Administrator is able to add fields as necessary. When a field is added, it is reflected in the Deal Master. A Product related information may include: Item Number, GBP Displayed Item Number, Item Specifications/Features, Item Dimensions, Item Colors, Item Imprint Methods, Item Imprint Locations, Item Imprint Areas, Item Packaging Information, Item Shipping Carton Size, Item Shipping Carton Weight, Item Number of Pieces Per Carton, Shipping From Zip Code, Item Images, Landed Cost, Negotiated Price, “Other Information” Text Field, Item Category with ability to select more than one, Item Sub-Category with ability to select more than one, Item Industry Recommendation(s). These information may be collected into and retrieved from the database via a Product Master 133 instance, Product Master 133 instances interact with Product Management 207 functions to feed to Content Management functions 115.

Content Management includes Product Library Management and Product Comparison. Product Library Management allows website Administers to manage which view styles are enabled or disabled for user use. These view styles may include: list, thumbnail, detailed and quick view. The website administrators are also able to enable product comparisons where a user can select “X” amount of items for a side-by-side comparison of features, images, etc. Product comparisons may be limited to 4-5 items for comparison at once.

For Product Comparison, Users are enabled to select multiple items for a side-by-side comparison. The website admin is able to set what information will be displayed in this comparison. The user has the ability to email the comparison, and to broadcast more than one item at once via the Broadcast methods and systems. The website admin can enable and disable the information that is displayed in these product comparisons from what are available in the Deal templates of the items from Deal Master System 129.

Content Management permits a user to add/remove graphical/sound content that is on the homepage. Additionally, a user is able to modify the content displayed within the banners and other graphics. For example, a user can choose to display or not to display “Featured Items” on the homepage. If the user chooses to display this, they are able to modify which items are displayed as featured items. For example, a user can choose to change the text in a banner from something like “Refer users for site credit” to “Refer users for a chance to win”.

Besides directly interacting with Account Management System 113 and Product Master System 133, Deal master System 129 also directly interacts with Broadcast System 131 to broadcast Deals to groups and users and other social networks, and with Alert System 139 to update to various users on the progress of any particular Deal. Deal Master 129 also directly calls on the Status Management system 209 to activate (211), inactivate (213) or to request (215) a Deal.

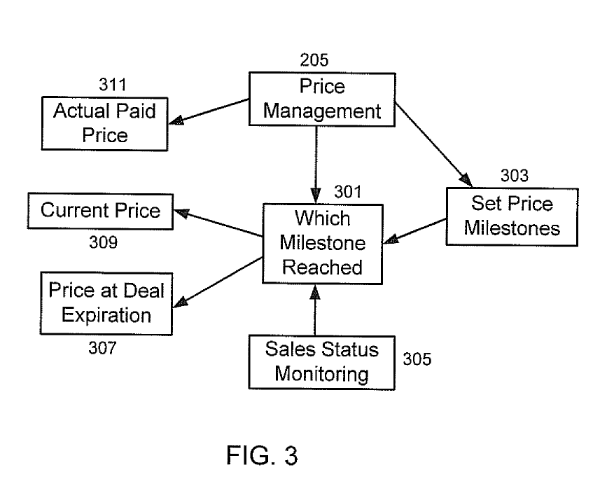

In reference to FIG. 3, Price Management system 205 functions to manage three prices: Actual Paid Price 311 by a user, registered or non-registered; Current Market Price 309 of a Deal; and Price 307 at Deal expiration. In accordance with a Deal structure, Price Management System 205 at step 303 may set up price milestones. When the Deal is activated, Price Management System 205 then sets market price 309 by querying Sales Monitoring Module 305 and checking if the sale has reached a particular price milestone at step 301.

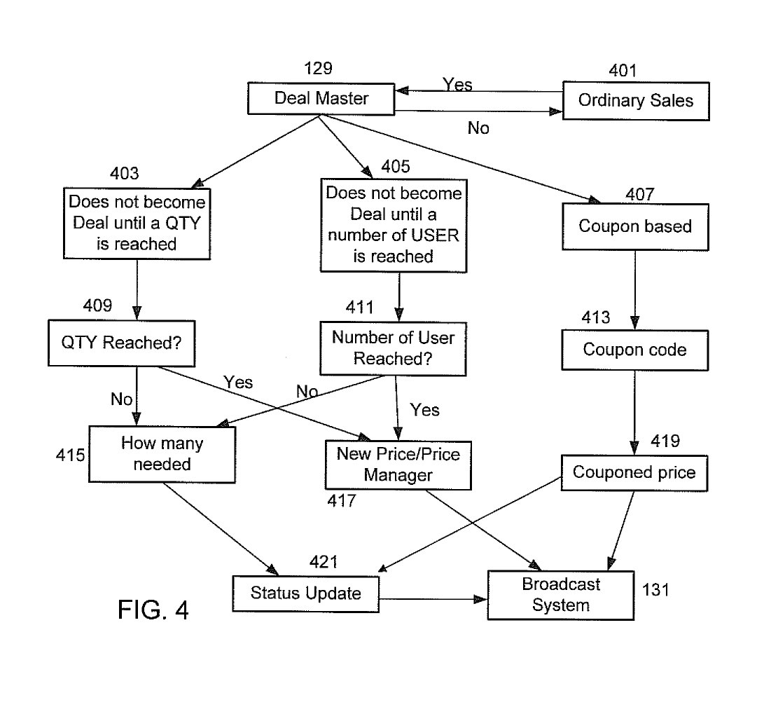

In reference to FIG. 4, Deals are created and managed by instances of Deal Master 129. Deals may only be created for items that are entered in the Product Master. The system may also allow for special Deals for items that are not entered in the Product Master by providing a temporary product arrangement account. The created Deal may not feature all information available in the Product Master or all imprinting capabilities available. The Deal creating user is prompted to choose what information will be displayed for each Deal, and certain information may be required for a Deal to be activated or displayed for activation on the website. Deal Master 129 then stores the Active, Inactive and Requested Deal information. A Deal creator can choose to duplicate other “Deals” to create new “Deals”.

When creating a Deal, the Deal creator is enabled to use preinstalled Deal templates, he/she then is prompted to complete, at minimum, the required information on a chosen Deal template and any additional information he/she would like to display. The Deal creator is prompted to review and approve the Deal before activating the Deal. Deals may only be modifiable by users authorized by Deal creators before the first order is placed for that Deal. After the first order is placed, any modifications to an active Deal may only be made by the system Administrator. But the system Administrator is able to make changes to these restrictions. Any changes may automatically trigger email notifications to users who have received Broadcasts or participated in the Deal. The Deal Master may also call on the Savings Calculation function to provide the savings in dollars and savings percent based on the overall Deal and the current price.

The required Deal Information for creating a Deal may include: Item Number, Item Name, Item Images, Item Features, Item Dimensions, Imprint Method(s), Imprint Location(s), Imprint Area(s), Item Colors, Item Packaging Information, etc. A Deal creator needs to post at least one image to activate a Deal. GBP may require at least six images to be available for display on the product template: a Main Image that enlarges when scrolled over; plurality of Thumbnail Images that when clicked, the main image changes to the selected thumbnail image. Preferably at least five thumbnail images are available for use. The Deal creator may not be required to use all thumbnail images. Website administrator is enabled to restrict the number of thumbnails for Deals. For example, the GBP website may permit a maximum of ten thumbnail images to be used. GBP may restrict this so all users can only use a maximum of six thumbnails. Hi-Resolution Images may not be displayed on the web page, but may be linked for a user for downloading. The required Deal Information may also include the Shipping Information, for example, Carton Size, Carton Weight, Number of Pieces per Carton, Shipping From, Zip Code, etc. Shipping Estimate may be calculated in the interfaces of Order Entry Process, Order Review, and/or at Set-up/Running/Other Product/Imprinting Related Charges. Other related Deal information fields includes: Deal Available to, Sub-Group Selection, Other Deal Information, Number of Times a Deal can be Broadcasted, Frequency/Amount of Time Required between Broadcasts and General Settings Set by website administrators. Website administrators can enable Deal creators to modify for their own Deals.

Deal Master 129 also implements a timer that calculates and activates a real time Deal Time Countdown. The timer does not begin until the Deal is activated either by the creator for a standard Deal or by the first order that is placed to request a Deal. The Deal status is updated based on the Deal time. Expired Deals are updated to an Inactive status upon expiring. Deal Master 129 interacts with Product Master System to render the Item Quantities and Pricing to be displayed in a Deal. The current price auto-adjusts according to the Deal type requirements and what triggers the adjustment for each Deal type. This price adjustment is also used for calculating the current savings for the Deal.

In operation, if a sale of an Item is not configured to be a Deal, the Item goes to Ordinary Sales 401. If an Item is then configured to be a Deal, Deal Master 129 then constantly monitors its sales status to decide its Deal status. If the sale does not become a Deal until a specified quantity of sale is reached in route 403, Deal Master 129 then periodically checks to see if the Quantity of sale is reached at step 409; and if the status is yes, new selling price would be automatically set with the Price Manager at step 417; if the status is no, then Deal Master calculates how many sales are needed to reach the Deal status at step 415, and Deal Status would be updated at step 421. Deal status would then be sent to the Broadcast system 131 to be broadcasted to various social networks and registered users.

If the sales does not become a Deal until a specified number of buyers are reached in route 405, Deal Master 129 would periodically check to see if the number of buyers is reached at step 411, if the status is yes, new selling price would be automatically set by Price Manager at step 417; if the status is no, then Deal Master calculates how many buyers are needed to reach the Deal status at step 415, and the Deal Status would be updated at step 421. A Deal Status would then be sent to the Broadcast system 131 to broadcast to various social networks and registered users.

If the Deal is coupon-based in route 407, a coupon code is provided at step 413 by Deal Master 129. When a coupon is used, a price with coupon is set by the Price Manager at step 419; the Deal Status is updated at step 421. A Deal Status is then sent to the Broadcast system 131 to be sent to various social networks and registered users.

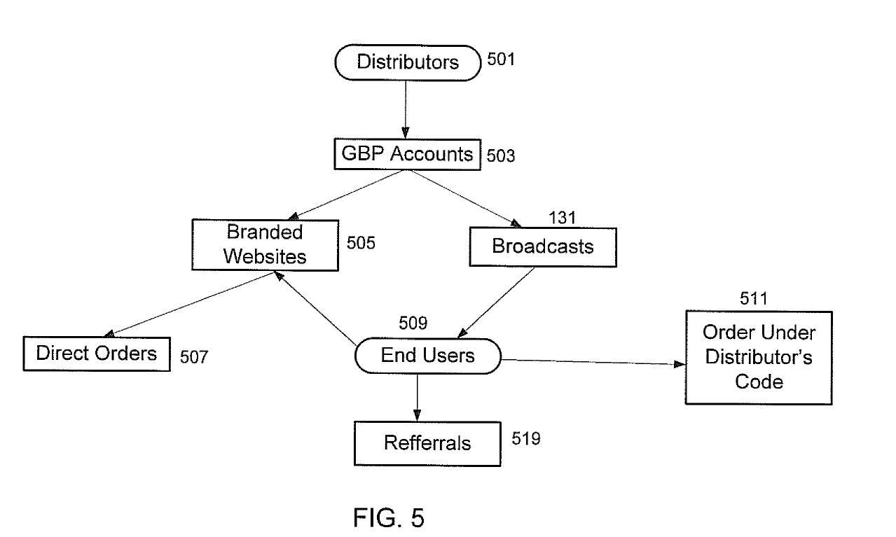

In reference to FIG. 5, the relationships between Distributor Users and End Users are shown. Distributor Users are allowed to construct GBP accounts 503 which enable the constructions of Branded Web sites 505 and the activation of customized Broadcast function 131 that is directly associated with accounts 503. Broadcast function 131 then interacts with various End Users at 509 about a Deal using the Distributor's Deal code. End Users 509 can either go to the Distributor's Branded Websites 505 to place an order, or directly place an order with the Broadcasted interface using the Distributor's Deal code at step 511. An End User 509 can also send out the Deal to other end users or networks through Referral Function 519. A buyer can also directly place an order at the Distributor's websites at step 507.

In one embodiment, End users may place orders on the GBP website strictly by permission from the Distributor and in a manner at the option of the Distributor. In one embodiment, an End User may register on a particular Distributor's private branded website and, if authorized to do so by the Distributor, can place orders directly on the system through the Distributor's account. This is referred to as “Distributor Branded End User Direct Ordering.”

If an End User is registered on a distributor's branded site but not authorized to place orders directly into the system, the End User may still be allowed to go through the same shopping experience as if they were authorized for direct ordering, but instead of the order going directly into the system, the website may simply generate an email to the distributor notifying them that their customer wishes to place an order and the email will contain all the particulars—item, color, quantity, etc.

For End users who are not registered through a distributor branded GBP website, they may be accessible by any distributor who may broadcast one or more GBP Deals to their customers via an email blast. The email would contain a hyperlink to a web page containing the Deal or Deals. If an end user chooses to place an order the end user would fill out a form containing basic information and the website would forward it by email to the Deal's Distributor. The distributor can click the hyperlink in that email to authorize the order to be entered automatically in the Distributor's account on the GBP website. This type of orders is referred to as a “Deal specific End User Ordering by Email.”

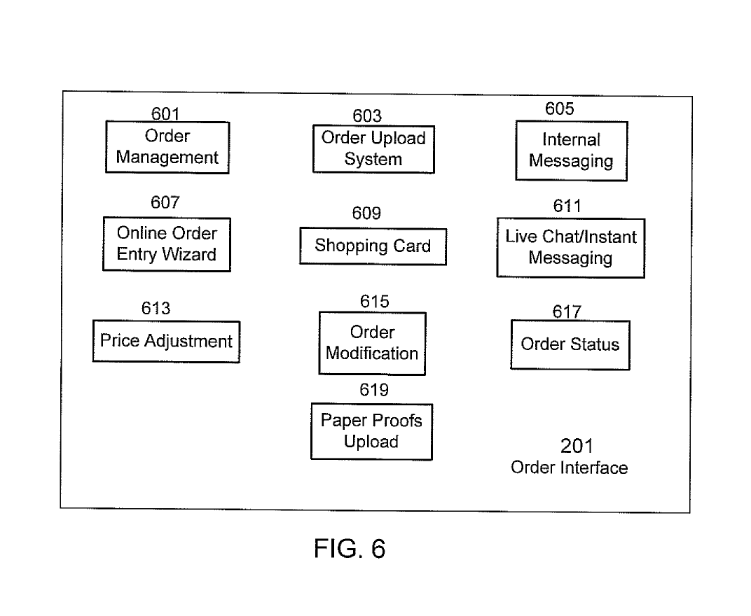

In reference to FIG. 6, an Order Interface 201 is implemented for all GBP websites, including the branded websites of Distributor users and Manufacturer's outlet stores. Order Interface 201 may call on various function modules to finish an order for a buyer. The functions may include, but not limited to, Order Management 601, Order Upload system 603, Internal Messaging system 605, Online Order Entry Wizard 607, Shopping Card 609, Live Chat/Instant Messaging function 611, Price Adjustment 613, Order Modification 615, Order Status function 617, and Paper Proof upload function 619.

When a GBP customer places an order on the GBP website; Order Interface 201 calls on Order Management 601 function to prompt a corresponding GBP purchase order form to be created. Order Interface 201 then communicates the GBP purchase order form to the back end product management system with adequate operable error checking functions, and then a corresponding sales order is created in the back end product management system.

Order Interface 201 is also responsible for all order-related communications from the GBP customer to GBP server system and to one or more back end product management systems; and from one or more back end product management systems to GBP system to the GBP customer. The interface follows appropriate “handshake” and error checking protocols to ensure information is accurately sent and received. A GBP system also enables Deal Owners to manage orders for their personally posted Deals via online Order Modification Function 615, Order Upload/Downloads function 603, etc. Deal Owners retain administrative rights to their own incoming orders, for example, the right to manage statuses, when to update statuses, and order alerts.

For an order placed online, Online Order Entry Wizard 607 is called upon. Order Entry Wizard 607 may be capable of identifying the information from the product sales master system and the current Deal, and is able to use this information to prompt the user to provide required information for his/her order. The features available for an item in the product sales master system may or may not be offered in a Deal. Order Entry Wizard 607 is able to identify what is and is not offered in the current Deal compared to what is offered in a product sales master. The wizard uses the product master to correlate the correct charges with the information that is entered by the user. These charges include but are not limited to: setting-up, running, paper proof, PMS color match and drop shipment. Upon completing their orders, users are able to download PDF/Excel versions of their up-to-date orders.

For example, Item “XYZ” is entered in the product sales master with three imprint locations and two imprint methods available. The current Deal offers one location and two imprint methods “A” and “B” in the Deal. The order entry wizard may only permit the customer to use the one imprint location and requires the user to select either imprint method “A” or “B”. The wizard compiles the charges for what is requested by the customer by pulling data from the product master for Item “XYZ” and Imprint method “A” or “B”. These charges are affected by the number of colors in the imprint, if PMS matches are requested or if the order is a repeat order. The wizard allows the user to access and select the archived data, including previous shipping addresses, account numbers and artwork for entry into the wizard.

For Order Upload System 603, it allows a customer to place an order with the purchase order number, order quantity and credit card information in a pre-written standard formats by directly uploading a PDF, JPEG, Excel etc. file; the customer may also include art information. Upon receiving this uploaded order, a GBP Representative will then enter it into the GBP wizard.

Information required immediately for creating an order may include: Customer Purchase Order Number, Order Quantity, Credit Card Information, Item Color(s), Imprint Method(s), Imprint Location(s), Imprint Color(s), Artwork, Paper Proof (Requested or Not), Repeat Order Number, Special Instructions for Printing or Packaging. In addition to the above mentioned requirements, user may need to provide the following information before an order can be shipped: Ship to Person's Name, Ship to Company Name, Ship to Street Address, Ship to City, State, Zip Code and Country, Shipping Method, Shipping Account Number, Requested Ship Date, Special Instructions for Shipping.

For Shopping Cart function 609, upon an order is entered either via the wizard function 607 or Order Upload system 603, a user is directed to a shopping cart, A payment gateway is used to process and store the user's credit card information. Once “apply” is selected, the shopping cart total is updated. The user is able to edit the amount they have entered and recalculate the total. The system may not allow the user to apply an amount higher than the site credit that is available to them in their account. Applying credit may simultaneously update the users account/credit balance. It may be configured that only one order can be placed in the shopping cart/paid for at a time.

On the other hand, the Price adjustment function 613 is linked with the Credit System 111. When a Deal criteria is reached or a Deal is cancelled, price is adjusted according to the structure of the Deal and credit is automatically calculated to a registered customer account.

For Order Modifications function 615, Users are enabled to see when there is a “hold” on their order. By clicking on the “hold” that is displayed, the user is directed to that section of the order entry wizard to supply the missing information, then the process continues as is directed for the order interface. Artwork uploads would generate an auto email to the necessary parties. For example, when a distributor uploads artwork for their order to the GBP website, the GBP PO is updated and the back end product management system sales order is updated. An email is then automatically generated that reflects the Group Buy PO# in the subject line and with the artwork attached. The email would be automatically forwarded to a specified email address such as art@primeline.com to be gathered and processed. Likewise, orders, changes and artwork may all be auto-sent to the designated email addresses provided by other users for their posted Deals. Users with Deal creation permissions may be asked to authorize this function in the Deal master. This information will apply for all Deals posted by that user.

For Paper Proof Upload function 619, a paper-proof may be uploaded to the back end product management system to reflect the user's approval or request a revision for placing an order. The system may place a paper-proof hold before the order goes through the system. Multiple versions of paper-proofs may be generated and the back end product management system periodically is updated to resolve the paper-proof hold for a final layout or to resolve the paper-proof hold to create another hold for a revised proof. This process may continue until the paper-proof is approved. The order then proceeds as usual. Paper Proof Upload function 619 then updates the back end product management system Sales Order, GBP Purchase Order and user order in the Order Interface.

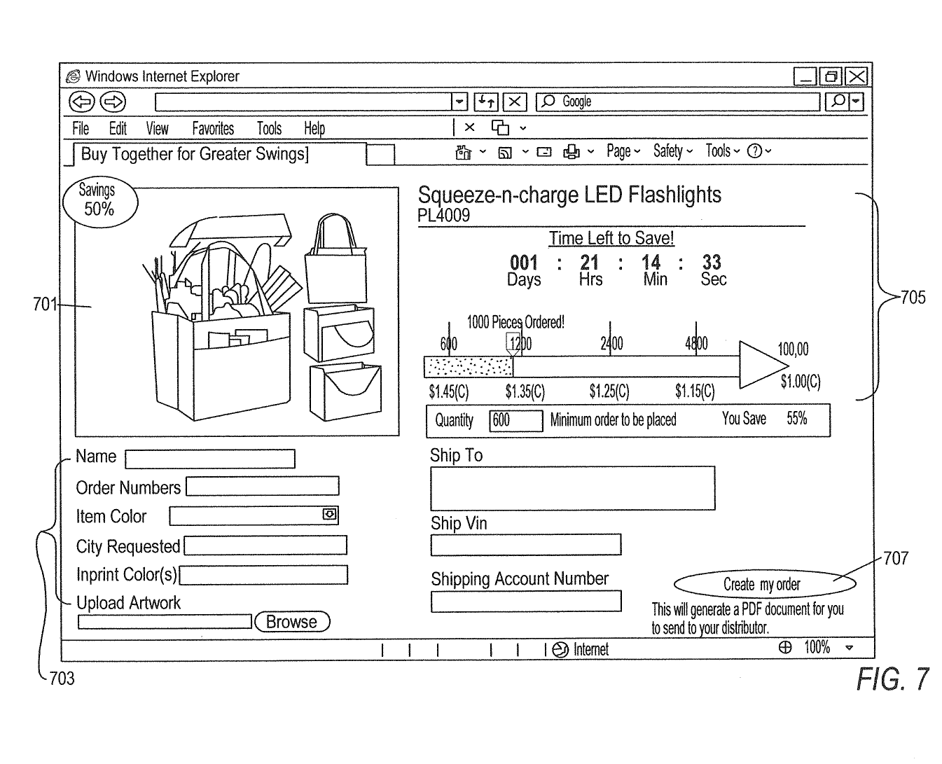

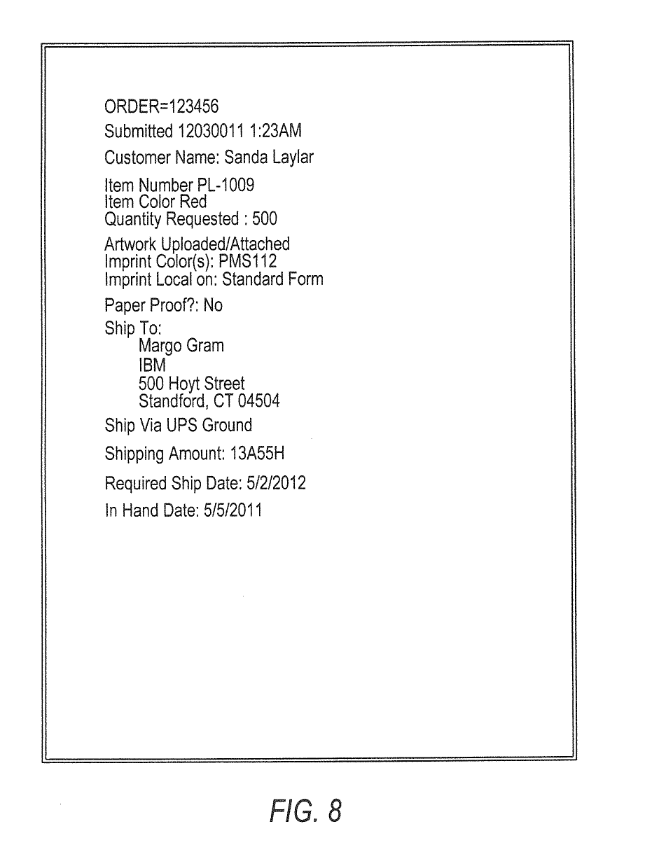

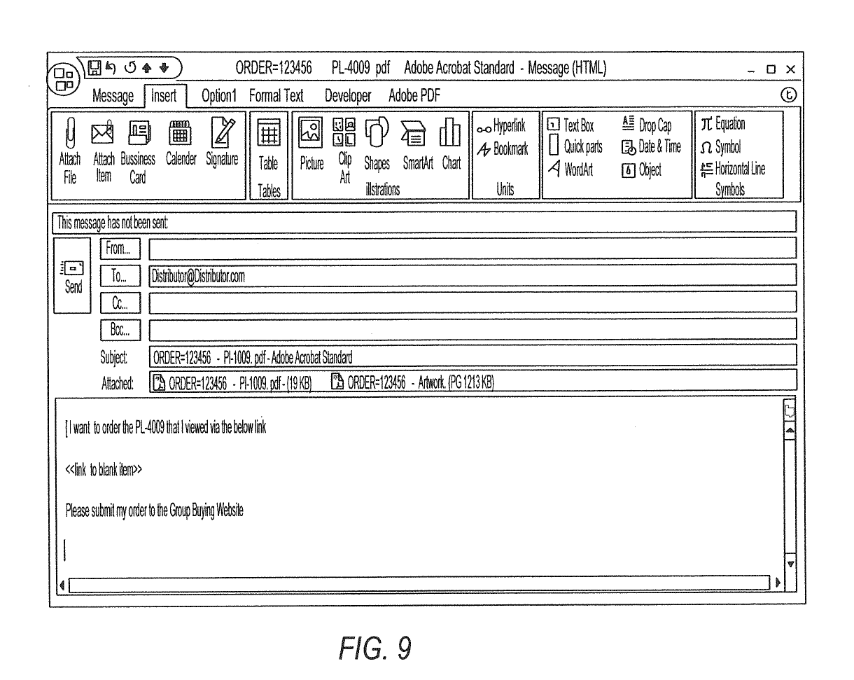

In reference to FIG. 7, an example Order Interface web-design is shown. Item image 701 is displayed on the interface and the present Deal status and the calculation of savings are displayed as 705. Orders may be generated through filling Order Fields 703 or through using the Order Wizard button 707. If an order wizard is used, a Purchase Order is automatically created as shown in FIG. 8. An email to the Deal creator or the Distributor of the Deal may be automatically generated as shown in FIG. 9 attached with the Purchase Order.

At least two types of severs may be involved. The GBP servers for taking purchase orders from customers, and the back end product management system servers for checking out items from storage and for management of shipping activities. Order Interface 129 performs the communication processes between these two server systems. Order Interface 129 communicates an order from the GBP system to the back end product management system for checking out items and for shipping, The interface may operate on a “batch” system to relay information between these servers on an hourly basis. Order Interface 129 also communicates a GBP purchase order to create a sales order in the back end product management system. Then the interface communicates order activity, holds, uploaded documents (i.e. paper proof/finals) and information (i.e. tracking) back to GBP system using a push mechanism. Order Status Updates are included within these communications. All order statuses may fall within three status categories: Pre-production, Production and Shipping. Modification restrictions may be applied based on what category the current order status falls into. For example, orders with any type of art-holds are in the “Pre-production” status category and can be modified based on the restrictions set for orders in the “Pre-production” status category. These modification restrictions, statuses and status categories can be modified by the website administrators.

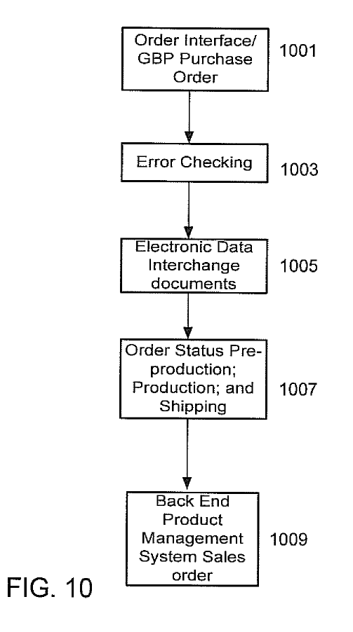

In reference to FIG. 10, at step 1001, Order Interface 129 on GBP system receives a Purchase Order. At step 1003, Order Interface 129 checks for errors in the database. And if the order information matches to the database record, Order Interface 129 at step 1005 creates electronic data interchange (“EDI”) documents and transmits them to the back end product management server system. The GBP system also conducts an error checking routine to manage these documents as to whether or not they have been transmitted and received by the back end product management system accurately. A batch system may be used for order integration. The batch system would relay the necessary information on an hourly basis. All information related to order updates and changes may be relayed and modified immediately on both systems.

GBP may generate a corresponding purchase order (“PO”) to its supplier(s) after a distributor successfully completes its order on the GBP website. The GBP PO would then be converted to generate a sales order on Supplier's ERP system. Error checking and appropriate handshake protocols are followed for these inter-server communications to ensure and verify that the data sent between the systems are accurately received. Upon receiving information of the current status of the sales at step 1007, the back end product management system updates the system and records the sales order in its system at step 1009. The back end product management systems may include any other, one or multiple third party product databases, manufacturers and distributors.

The current status of a sales order in a Supplier's system may be reflected on GBP system and Order Interface. For example, if there is some type of hold in Supplier's system, that hold would be reflected to the distributor on his GBP website. Similarly, if the order has shipped and tracking information is available in the Supplier's system, that tracking information would be reflected on the GBP website.

Order Interface may be implemented with a push mechanism in which an agent function may be implemented to be triggered by a status change on a Supplier's system and the agent may initiate a communication of that information to the GBP website.

At which stages an order may be changed via online system by a GBP's customer are noted and displayed. For example, before an order goes into production at Supplier's facility, most changes can be made such as to the imprint location, product color, etc. However, in the following stages of processing, order changes may be restricted.

For example, during pre-production stage which may begin at the time a GBP order is received in its system and may end when the final layout is reported or as started on a Supplier's system, any changes may be made by a GBP customer on the GBP website. In a during-production stage which may begin immediately after the final layout is started on a Supplier's system and may end when the order is produced and packaged, i.e. the order is recorded as completed on Supplier's system, any change may be requested via phone call or internal site communication. During shipping stage which may begin immediately after the order is packaged and end when the order is shipped, i.e. order has been marked as shipped in a Supplier's system and tracking number has been provided, no changes may be made.

For Alert Management system 139, there may be three types of automated alerts: Automated Standard User Alerts, Automated Standard Order Alerts, Automated Opt-in Alerts. Standard user alerts are sent via email and are triggered by user actions on the a website. Example standard user alerts may include, but not limited to, Account Approval, Confirmation of Email, Account Successfully Activated, User Information Modified/Updated, etc. A website administrator may be configured to be able to modify, enable and disable these alerts.

Order Alerts are sent via email and are triggered at specific points throughout the order process based on the settings determined by the website administrator. Order alerts may be enabled and disabled by the website administrator. The order history log tracks alerts and changes made to an order. The website administrator is able to modify, enable and disable these alerts. Order alerts may include: 1) Order Status Update, 2) Missing Information Reminders, 3) Confirmation of Changes, 4) Price Change. Order Status Update alert may be triggered each time the status of the order changes. Order Status Update alert may include, but is not limited to: Order Received with acknowledgement, Order in Production, Order Shipped with Tracking, Card Charged, etc. Missing Information Reminders alert may be triggered every some number of days that any information is missing from an order. The website administrator is able to set this timeframe as well as what missing information triggers these alerts. Confirmation of Change Alert may be triggered anytime when anything is manually changed on an order which would relay the old and the new information to the customer. Price Change alert may be triggered by pre-shipping savings or post shipping for site credit earned.

Opt-in Alerts are optional email alerts sent to users based on the information they have selected in their preferences. Users may choose to be notified for specific scenarios. Opt in Alerts include, but are not limited to, Newsletters, Product/Deal Alerts of New Products, Products of Interest, Ending Soon, Price Drops, etc., “Increase Your Order”, Bookmarked Items of Price Change, “Ending Soon”, Broadcast activities. The website administrator is allowed to modify, enable and disable these alerts. Users have opt-in options at user sign up and in their Account/Preferences Section. These alerts are linked to the item master based on what items and what specific categories or what specific industry recommendations. Users can opt-in to receive all alerts or check selected preferences.

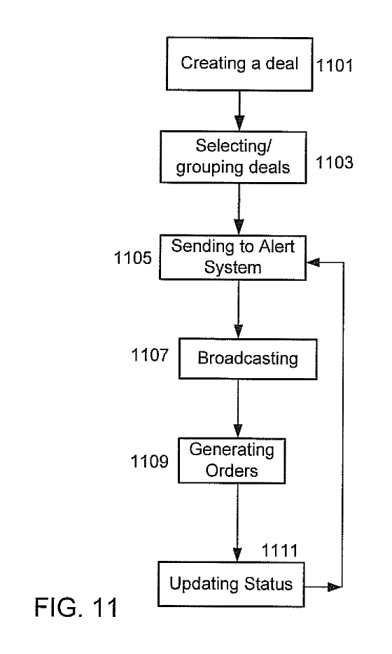

An example activation process of the Alert Management function is shown in FIG. 11. After a user creates a Deal at step 1101, he/she may choose to group the Deal with other Deals at step 1103, the grouped Deals are then passed to the Alert system at step 1105, and then the Broadcast function is triggered at step 1107. After an order is generated at step 1109, the Deal status is updated at step 1111, and the update status may trigger another round of alert broadcasting.

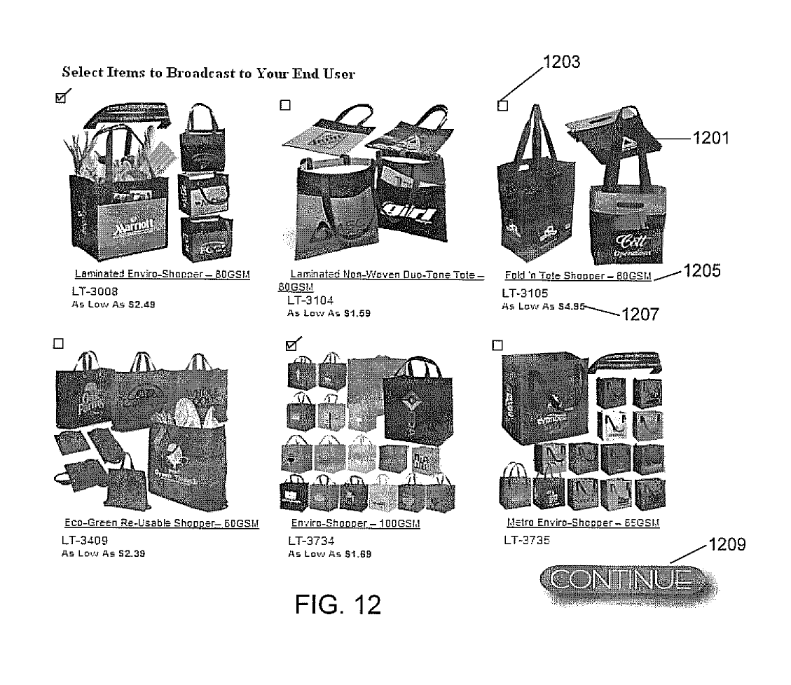

An example Broadcast Interface is shown in FIG. 12. Multiple Deal item images 1201 may be displayed for selection check 1203. A brief item description 1205 is added as well as its price 1207. A Click of the “Continue” button 1209 would trigger the Broadcast function to send automatic emails to various user groups and social networks.

Broadcasts may be in the form of alerts formatted to advertise an update or Deal sent by users in multiple forms. Particular Deals may have specific Broadcast templates. Based on how a user requests to be broadcasted, the Broadcast templates may be customized with header/footer to upload a company logo. The website administrator may enable or disable template customization and enable or disable how Deals can be broadcasted overall and on an individual Deal basis. The website administrator may be able to create, modify and delete templates. Website administrator may be able to manage the Broadcast system and see what alerts have been sent.

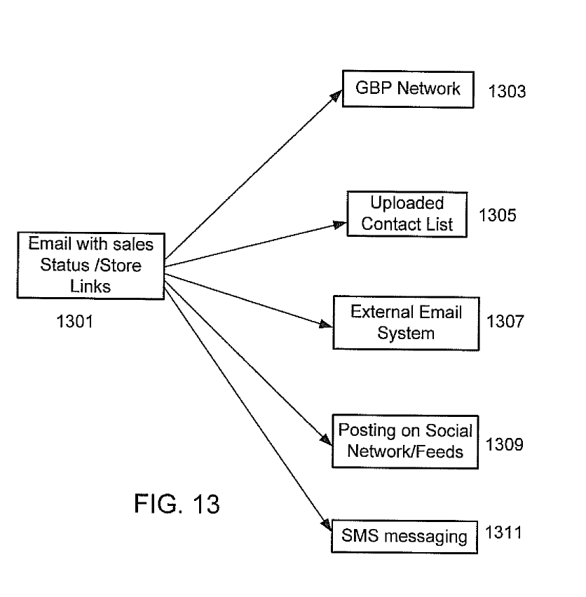

In reference to FIG. 13, Broadcasts may be generated in email formats with sale status and store links at step 1301. A Broadcast may be sent to a GBP network 1303. A list of receivers 1305 may be uploaded, and a list of external email receivers 1307 may be uploaded through external email servers. A Broadcast may be posted to various groups on social networks 1309 through social network accounts. A Broadcast can also be sent through SMS messaging system 1311.

In sending Broadcast as an Email to a GBP Network, users may need first to opt-in to receive Broadcasts for specific product categories, industry types, etc. Then a user is able to broadcast a Deal to all users who have previously accessed that Deal and/or have opted-in to receive Broadcasts for that Deal's category, or industry, etc. The Broadcast is then sent from a GBP email address. The sending user may be able to see how many users have received this Broadcast. A Deal Master may track dates and times of a Broadcast. The website administrator may be able to limit the number of times and the frequency of which a user can broadcast a Deal. These permissions may be standard for all Deals, but may be modifiable on an individual Deal basis. For example, the website administrator may only allow a specific Deal to be broadcasted to an internal network once every day, or once every hour, etc., or the website administrator may choose to allow a specific Deal to be only broadcasted 5 times or 25 times in total on the internal network.

To send a Broadcast as an Email on an Uploaded Contact List, a user first uploads an email contact list to their GBP account. Then the Broadcast system generates a Broadcast for the Deal and sends the Broadcast via the email server from the email address of the requesting user to the Uploaded Contact List. The requesting user is able to select which contacts on List this Broadcast will be sent to. The broadcast may have a customizable header/footer for the requesting user's company logo to be uploaded. The requesting user can simply log into an existing account to send GBP Broadcast/advertisements through that system without leaving the GBP website.

To send a Broadcast as an External Email, a User is allowed to export a Broadcast from the GBP website to an external email system. This enables the user to send this Broadcast using their personal email address without having to upload any information to the GBP system. This Broadcast template may be a customized with header/footer to be uploaded.

To post a Broadcast on a social network or as feeds, a Broadcast is generated through the Broadcast system, is then uploaded automatically to a specific public forum, for example, a group on Facebook, LinkedIn, MySpace, Twitter and/or RSS feeds. A User can send a Broadcast template via an SMS Picture Message system.

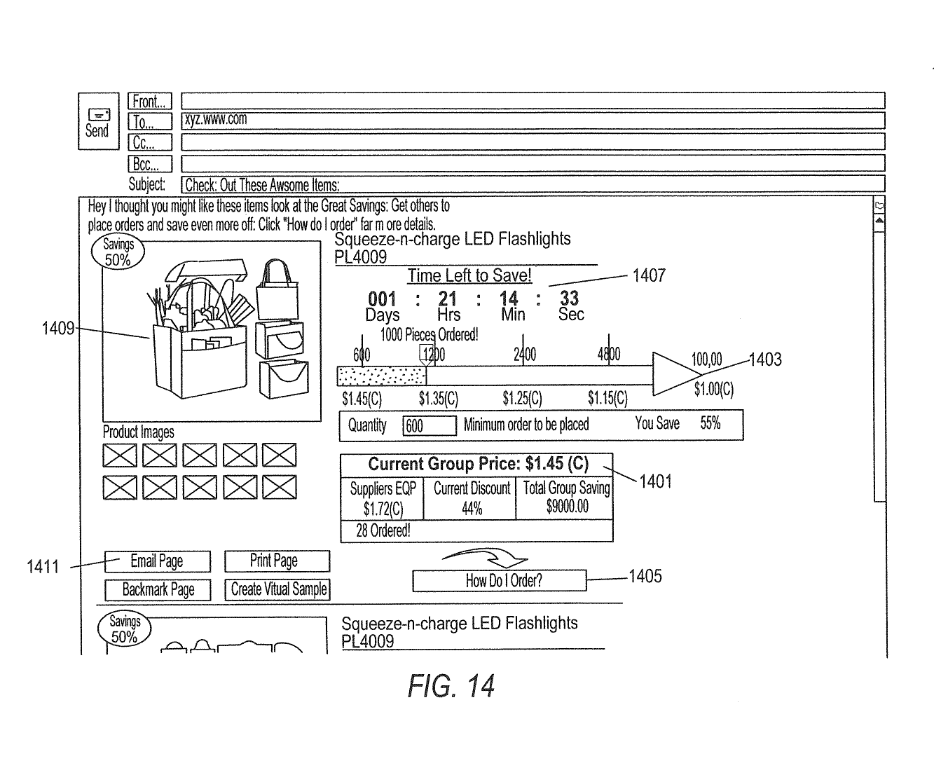

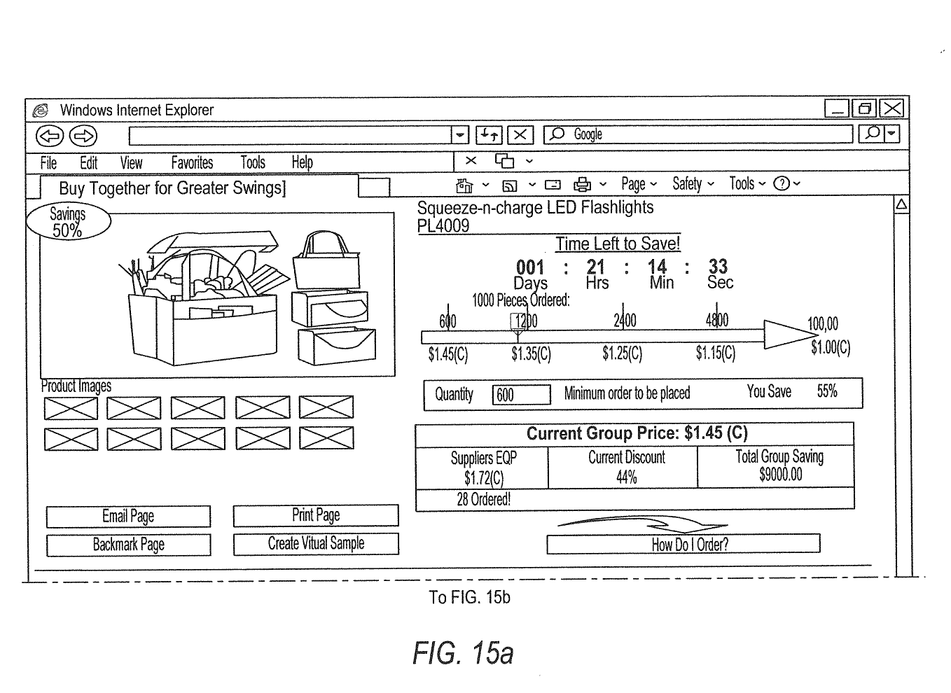

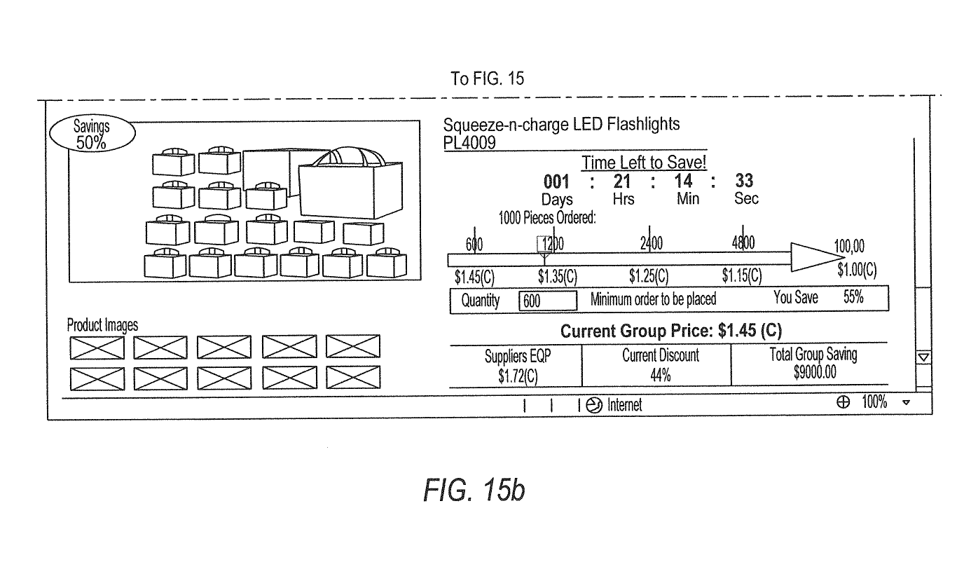

Example Broadcasts via email or web postings are shown in FIG. 14 and FIG. 15. The Broadcast is formatted email with a webpage design that may include a group of Deals. Information about a deal may include: Deal item image 1409, Deal time left 1407, current Deal status 1403, Deal savings 1401, Order information 1405, and further Email links 1411.

FIG. 17 shows an example list of other user tools in a GBP system: Measurement tools 1701, “Snag it” proof modification 1703, Time Zone adjustment 1705, Budget Slider 1707, Find a Distributor 1709, etc.

Report Generator 1713 can generate, view and export (in Excel and PDF format) various reports in various formats. For example, a report of Deal may include: a calculated saving per Deal or “Deals” in a specified category, timeframe, User Group, Deal type or Deal Status; report of sales figures per revenue, COGS, gross profit, net earnings. Other reports may include: report of number of participants; report of prices and dates of price changes; report of number of orders; report of quantity of each order; report of average pieces per order; report of savings at time the order was placed, shipped and when Deal was closed; report of site credit earned; report of ship to destinations; report of Broadcast results.

A Poll Management functionality 127 may also be implemented. The website admin is able to create polls for GBP users to participate in. Users can participate in polls whether or not they are logged in to GBP. Users can participate in each poll only once. Upon participating in the poll, the graphical results are displayed in the place of the poll.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

None of the descriptions in the present application should be read as implying that any particular element, step, or function is an essential or required element which must be included in every claim scope. It will be understood that the scope of the patented subject matter is defined only by the allowed claims. Moreover, none of these claims are intended to invoke paragraph six of 35 USC section 112 unless the exact words “means for” are followed by a particular functional or operational phrase. It is additionally noted that methods of operation and function for the proposed inventions are contained herein, and that these descriptions will be understood as being within the disclosed claim scope and subject matter should the claims be so modified to distinctly claim method steps.

The claims as filed are intended to be as comprehensive as possible, and no subject matter is intentionally relinquished, dedicated, or abandoned.

What is claimed is:

1. An electronic system for automated promoting of group shopping, said system comprising:
a plurality of computer processors, wherein said computer processors are functionally instructed to perform a plurality of modular functions, said modular functions comprising:
a Deal Master module enabling a user to create and post a Deal for an item, said Deal being structured with a plurality of sale milestones;
wherein a buyer is charged at a first current price to place an order for the item, said order is committed in the system and processed and charged to said buyer immediately upon receiving said order, once a sale milestone of the item is reached, a second current price is automatically set to a next level for the item, and said buyer is automatically credited with a credit by the system;
a Sale Status module updating a status of a Deal progressing in real time;
a Broadcasting module generating a Broadcast post and posting the Broadcast post to a plurality of recipients;
an Account Management module providing a registration for a user and an access to said electronic system to a registered user;
an Order Interface module providing a plurality of Order processing functionalities; and
a Referral System module that allows a user to send a Deal to another user and to gain a referral credit;
wherein said Deal Master module, said Sale Status Module, said Broadcasting module, said Account Management module, said Order Interface, and said Referral System module interact with each other operatively, and interact operatively with a back end Product Management module that stores and updates product information in a database.

2. The electronic system of claim 1, wherein said sale milestone is reached upon a number of order-placing users being reached.

3. The electronic system of claim 1, wherein said milestone is reached upon a number of coupons entered being reached.

4. The electronic system of claim 1, wherein said Deal is constructed with a “Active”, an “Inactive” and a “Request” status, wherein said “Active” status is when said Deal is activated at a specific time and a user can place an order under said Deal, said “Inactive” status is when said Deal is expired after said specific time and a user cannot participate said Deal, said “Request” status is when said Deal is posted but has not been activated.

5. The electronic system of claim 1, wherein said Sale Status module updates a sale status of an item in real time, said sale status includes sold item's quantity, purchasing user quantity, progress of a Deal, and a Deal's current price.

6. The electronic system of claim 1, wherein said Broadcast post includes a plurality of Deal statuses.

7. The electronic system of claim 6, wherein said Broadcast post is broadcasted through an automated email function to a plurality of users.

8. The electronic system of claim 6, wherein said Broadcast post is broadcasted through a Distributor email system to a plurality of group members.

9. The electronic system of claim 6, wherein said Broadcast post is broadcasted through a Distributor email system to a plurality of group members.

10. The electronic system of claim 6, wherein said Broadcast post is broadcasted automatically to a public forum of a group in a social network.

11. The electronic system of claim 1, wherein said Order Interface allows for an uploading of a document of virtual proof functioning as a seal.

12. The electronic system of claim 1, wherein said Order Interface generates a Purchase Order document to be sent to a seller via an attachment to a message.

13. The electronic system of claim 12, wherein said message is an email message.

14. The electronic system of claim 1, wherein said Account Management module interacts with a Credit System wherein said Credit System provides credits to a registered user who participates a Deal upon said Deal expiration.

15. The electronic system of claim 1, further comprising:
an Alert management system sending customized alert to a plurality of alert recipients.

16. The electronic system of claim 1, wherein said Referral System enables a registered user to be rewarded for soliciting another user to use said electronic system for automated promoting of group shopping.

17. A method for promoting of group shopping, said method comprising the steps of:
implementing a plurality of computer processors, wherein said computer processors are functionally instructed to perform a plurality of modular functions, said modular functions comprising:
a Deal Master module enabling a user to create and post a Deal for an item, said Deal being structured with a plurality of sale milestones;
wherein a buyer is charged at a first current price to place an order for the item, said order is committed in the system and processed and charged to said buyer immediately upon receiving said order, once a sale milestone of the item is reached, a second current price is automatically set to a next level for the item, and said buyer is automatically credited with a credit by the system;
a Sale Status module updating a status of a Deal progressing in real time;
a Broadcasting module generating a Broadcast post and posting the Broadcast post to a plurality of recipients;
an Account Management module providing a registration for a user and an access to said electronic system to a registered user;
an Order Interface module providing a plurality of Order processing functionalities; and
a Referral System module that allows a user to send a Deal to another user and to gain a referral credit;
wherein said Deal Master module, said Sale Status Module, said Broadcasting module, said Account Management module, said Order Interface, and said Referral System module interact with each other operatively, and interact operatively with a back end Product Management module that stores and updates product information in a database.

18. The method of claim 17, wherein said sale milestone is reached upon a number of order-placing users being reached.

19. The method of claim 17, wherein said milestone is reached upon a number of coupons entered being reached.

20. The method of claim 17, wherein said Deal is constructed with a “Active”, an “Inactive” and a “Request” status, wherein said “Active” status is when said Deal is activated at a specific time and a user can place an order under said Deal, said “Inactive” status is when said Deal is expired after said specific time and a user cannot participate said Deal, said “Request” status is when said Deal is posted but has not yet been activated.

21. The method of claim 17, wherein said Sale Status module updates a sale status of an item in real time, said sale status includes sold item's quantity, purchasing user quantity, progress of a Deal, and a Deal's current price.

22. The method of claim 17, wherein said Broadcast post includes a plurality of Deal statues.

23. The method of claim 22, wherein said Broadcast post is broadcasted through an automated email function to a plurality of users.

24. The method of claim 22, wherein said Broadcast post is broadcasted through a Distributor email system to a plurality of group members.

25. The method of claim 22, wherein said Broadcast post is broadcasted through a Distributor email system to a plurality of group members.

26. The method of claim 22, wherein said Broadcast post is broadcasted automatically to a public forum of a group in a social network.

27. The method of claim 17, wherein said Order Interface allows for uploading a document of virtual proof functioning as a seal.

28. The method of claim 17, wherein said Order Interface generates a Purchase Order document to be sent to a seller via attachment to a message.

29. The method of claim 28, wherein said message is an email message.

30. The method of claim 17, wherein said Account Management module interacts with a Credit System functionality wherein said Credit System provides credits to a registered user who participates a Deal upon said Deal's expiration.

31. The method of claim 17, further comprising the step of:
providing an Alert management system sending customized alert to a plurality of alert recipients.

32. The method of claim 17, wherein the Referral System enables a registered user to be rewarded for soliciting another user to use the electronic system for automated promoting of group shopping.
